(19) United States
(12) Patent Application Publication
(10) Pub. No.: US 2023/0160593 A1
(43) Pub. Date: May 25, 2023

(54) Behavioral Change Promoting Device, Behavioral Change Promoting System, and Behavioral Change Promoting Method

(71) Applicant: Hitachi, Ltd., Tokyo (JP)

(72) Inventors: Hiroyuki OOTA, Tokyo (JP); Nobuyuki SUGII, Tokyo (JP); Masaaki FUJIMORI, Tokyo (JP); Tomoyuki OKU, Tokyo (JP)

(73) Assignee: Hitachi, Ltd., Tokyo (JP)

(21) Appl. No.: 17/994,066

(22) Filed: Nov. 25, 2022

(30) Foreign Application Priority Data
Nov. 24, 2021 (JP) 2021-190519

(51) Int. Cl. F24F 11/62

(52) U.S. Cl. CPC F24F 11/62; F24F 2110/20

(57) ABSTRACT

An object of the invention is to control an environment such that both external constraints and human comfort are unconsciously and easily achieved. A behavioral change promoting device according to the invention is connected to a control target device configured to act on an environment of a human, an operation unit configured to receive an operation performed on the control target device by the human, and a sensor configured to acquire a control target measurement value in the environment. The behavioral change promoting device includes: a change speed control unit configured to determine, based on the received operation, a change speed at which the control target measurement value is changed in a non-comfort direction of the human.

### BACKGROUND OF THE INVENTION

### 1. Field of the Invention

The present invention relates to a behavioral change promoting device, a behavioral change promoting system, and a behavioral change promoting method.

### 2. Description of the Related Art

In many cases, pursuing comfort related to five human senses is in a trade-off relationship with external constraints such as energy-saving achievement and health maintenance. That is, in order to satisfy the external constraints, each individual often needs to slightly sacrifice self-comfort. For example, in air-conditioning control, comfort of a person in a room is in a trade-off relationship with necessity for energy saving. To solve such a problem, behaviors are generally changed using persuasion for compliance with moral standards, a nudge having visualization effects, or the like.

(Zack Brown et al., Testing the effect of defaults on the thermostat settings of OECD employees, Environment Working Paper NO. 51, Organization for Economic Co-operation and Development, 5 Dec. 2012, pp. 1-17 (Non-Patent Literature 1) reports a time-series change in an initial (default) temperature set by an administrator and a time-series change in a set temperature requested by a user of an indoor air conditioner in an office building during heating in winter. According to the report, when the administrator slightly decreases the initial temperature, the user is accustomed to the change and slightly decreases the set temperature. However, when the administrator excessively decreases the initial temperature, the user feels uncomfortable and conversely increases the set temperature (described in detail later).

It is an object to end competition between the administrator and the user for increasing and decreasing the temperature as described above, and to satisfy both the external constraints and the comfort of the user to some extent. However, Non-Patent Literature 1 does not mention a method for specifically determining a change speed of a temperature that satisfies the object. In an environment in which a push button of a remote controller is at hand, on a wall, or the like and the user can easily change the set temperature, it is difficult to prompt the user to change behaviors from a viewpoint of energy saving.

### SUMMARY OF THE INVENTION

Therefore, an object of the invention is to control an environment such that both external constraints and human comfort are unconsciously and easily achieved.

A behavioral change promoting device according to the invention is connected to a control target device configured to act on an environment of a human, an operation unit configured to receive an operation performed on the control target device by the human, and a sensor configured to acquire a control target measurement value in the environment. The behavioral change promoting device includes: a change speed control unit configured to determine, based on the received operation, a change speed at which the control target measurement value is changed in a non-comfort direction of the human.

Other units will be described in embodiments for carrying out the invention.

According to the invention, it is possible to control an environment such that both external constraints and human comfort are unconsciously and easily achieved.

### BRIEF DESCRIPTION OF THE DRAWINGS

FIG. 1 is a diagram illustrating main points of Non-Patent Literature 1.

FIG. 2 is a diagram showing a relationship between a time-series change in a temperature and a time at which an elderly user presses a button.

FIG. 3 is a diagram showing a relationship between a time-series change in the temperature and a time at which a young user presses a button.

FIG. 4 is a diagram showing a relationship between an age of a user and a button pressing frequency.

FIG. 5 is a diagram showing a relationship between the age of a user and a button pressing speed.

FIG. 6 is a diagram showing a relationship between the age of a user and a button pressing pressure.

FIG. 7 is a diagram showing a relationship between the age of a user and a threshold of a temperature change speed until which the button is pressed.

FIG. 8 is a diagram showing a time-series change in a sensor temperature in a cooling environment in summer in the related art.

FIG. 9 is a diagram showing a time-series change in a sensor temperature in a cooling environment in summer according to a first embodiment.

FIG. 10 is a diagram showing a configuration and the like of a behavioral change promoting device.

FIG. 11 is a diagram showing an example of change speed information.

FIG. 12 is a flowchart of a processing procedure.

FIG. 13 is a diagram showing a time-series change in the sensor temperature in the processing procedure in FIG. 12.

FIG. 14 is a diagram showing a time-series change in the sensor temperature according to a second embodiment.

FIG. 15 is a diagram showing a time-series change in a sensor volume according to a third embodiment.

FIG. 16 is a diagram showing a time-series change in a sensor load amount according to a fourth embodiment.

FIG. 17 is a diagram showing a time-series change in a sensor color temperature according to a fifth embodiment.

FIG. 18 is a diagram showing a time-series change in a fragrance concentration according to a sixth embodiment.

### DESCRIPTION OF THE PREFERRED EMBODIMENTS

Hereinafter, a mode for carrying out the invention (referred to as the “present embodiment”) will be described in detail with reference to the drawings and the like. The present embodiment includes first to sixth embodiments. The first embodiment relates to air-conditioning control of cooling. The second embodiment relates to air-conditioning control of heating. The third embodiment relates to volume control. The fourth embodiment relates to load amount control of a training device for rehabilitation or training. The fifth embodiment relates to control of a color temperature of illumination. The sixth embodiment relates to control of a fragrance concentration. Hereinafter, the representative first embodiment will be mainly described.

### First Embodiment

### Terms and the Like

A control target device is an air conditioner.

A user is a user (human) of the control target device. The control target device acts on an environment of a user (human) stayed in an office or the like.

A sensor temperature is an actual temperature measured by a sensor, and is a temperature (control target measurement value) to be controlled.

The environment is a situation surrounding a human. In the first embodiment, the control target device (air conditioner) acts on the human environment in that a temperature, humidity, a wind speed, a wind direction, and the like (control target measurement values) of a space surrounding the human can be made variable. The expression “acts on the human environment” also means acting on human sensation via the environment. The sensation includes five senses (sight, hearing, touch, taste, and smell), a temperature sense (warm sense and cold sense), a force sense, and the like.

An administrator is a person who manages the sensor temperature from a comprehensive viewpoint (external constraints from viewpoints of individual users) of energy saving or the like while away from viewpoints of comfort of the individual users. “Human” means not an administrator but a user.

A target temperature is a target temperature to which a sensor temperature is guided. An object of air-conditioning control is to make the sensor temperature equal to or close to a predetermined target temperature while constantly detecting the sensor temperature and changing output or the like of the air conditioner. The target temperature is divided into an administrator specified temperature and a user set temperature.

The administrator specified temperature is a temperature determined by the administrator based on the external constraints such as energy saving.

The administrator specified temperature is further divided into an upper limit temperature, an initial temperature, and a lower limit temperature.

The upper limit temperature is an upper limit of the target temperature determined from a viewpoint of maintaining health of the user.

The lower limit temperature is a lower limit of the target temperature determined from the viewpoint of maintaining the health of the user.

The initial temperature is a so-called “default” temperature, and is a target temperature when there is no user set temperature (described later) having a higher priority order than the “default” temperature, or is a target temperature that reaches the user set temperature after a predetermined time has elapsed.

The user set temperature is a temperature determined by the user from a viewpoint of personal comfort. The user set temperature becomes the target temperature in preference to the initial temperature. Hereinafter, when simply referred to as a “set temperature”, the “set temperature” means the “user set temperature”.

### Contents of Non-Patent Literature 1

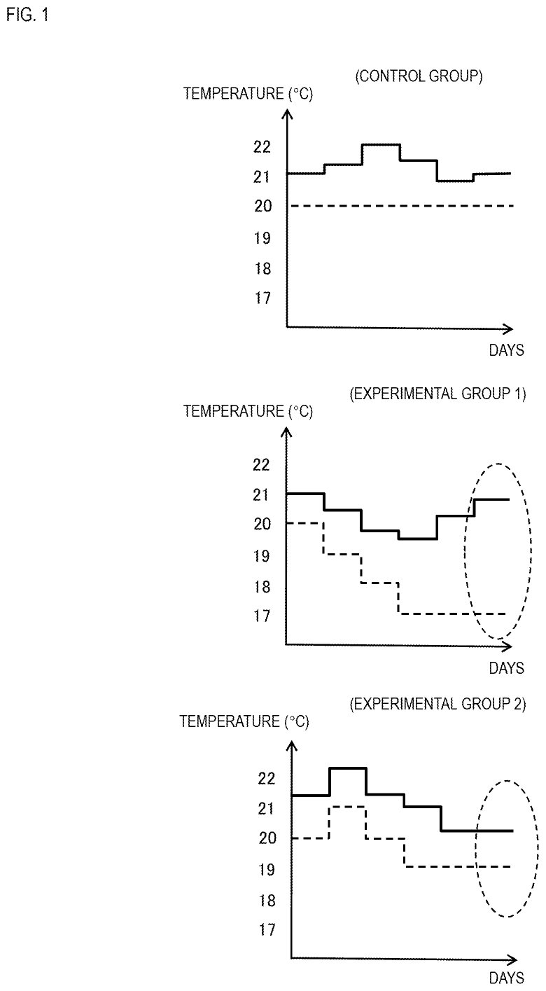

FIG. 1 is a diagram illustrating main points of Non-Patent Literature 1. In Non-Patent Literature 1, users are classified into three groups for each office space during an experiment period of six weeks in a heating environment in winter. The three groups are a “control group”, an “experimental group 1”, and an “experimental group 2”. An administrator determines an initial temperature that is not to be known to the users. The users can determine a set temperature by button operations regardless of the initial temperature.

An upper diagram of FIG. 1 shows a time-series change in the initial temperature (broken line) for the control group and in set temperature (solid line) based on the control group. In a space in which the control group is present, the initial temperature is 20° C. during an entire experiment period. The set temperature is changed every day, and is stable around 21° C. over the entire period.

A central diagram of FIG. 1 shows a time-series change in the initial temperature (broken line) for the experimental group 1 and the set temperature (solid line) based on the experimental group 1. In a space in which the experimental group 1 is present, the initial temperature is 20° C. in a first week, is decreased by 1° C. every week thereafter, and is unchanged at 17° C. during fourth to sixth weeks. The set temperature is 21° C. in the first week, and is gradually lowered every week until the fourth week, and then is gradually increased. As a result, the set temperature of the sixth week is almost the same as the set temperature (21° C.) in the first week.

A lower diagram of FIG. 1 shows a time-series change in the initial temperature (broken line) for the experimental group 2 and the set temperature (solid line) based on the experimental group 2. In a space in which the experimental group 2 is present, the initial temperature is 20° C. in a first week, is increased to 21° C. in a second week, is decreased by 1° C. in either of a third week and a fourth week, and then is unchanged at 19° C. The set temperature exceeds 21° C. in the first week, is increased to more than 22° C. in the second week, and then is decreased or maintained without being increased.

The sixth week of the experimental group 1 and the sixth week of the experimental group 2 (indicated by broken-line ellipses) are compared. The initial temperature is higher in the experimental group 2. However, the set temperature is lower in the experimental group 2. This means that the set temperature does not increase unless the initial temperature is rapidly decreased, that is, the user does not take an action of increasing the set temperature in response to a slow fall of the set temperature.

### Undisclosed Experiment by Inventors

Unlike Non-Patent Literature 1, inventors simulated a cooling environment in summer and conducted an undisclosed experiment as follows.
A temperature in an office is precisely controlled by an air conditioner.
Temperature sensors are disposed at four positions on a desk in the office.
The air conditioner rapidly changes the temperature in the office at a certain time and slowly changes the temperature in the office at a certain time.
In the office, the user is required to work at the desk.
When the user feels “hot”, the user presses a “hot button” on the desk.
When the user feels “cold”, the user presses a “cold button” on the desk.
Either of the hot button and the cold button includes a pressure sensor that measures pressure at which the user presses the button.

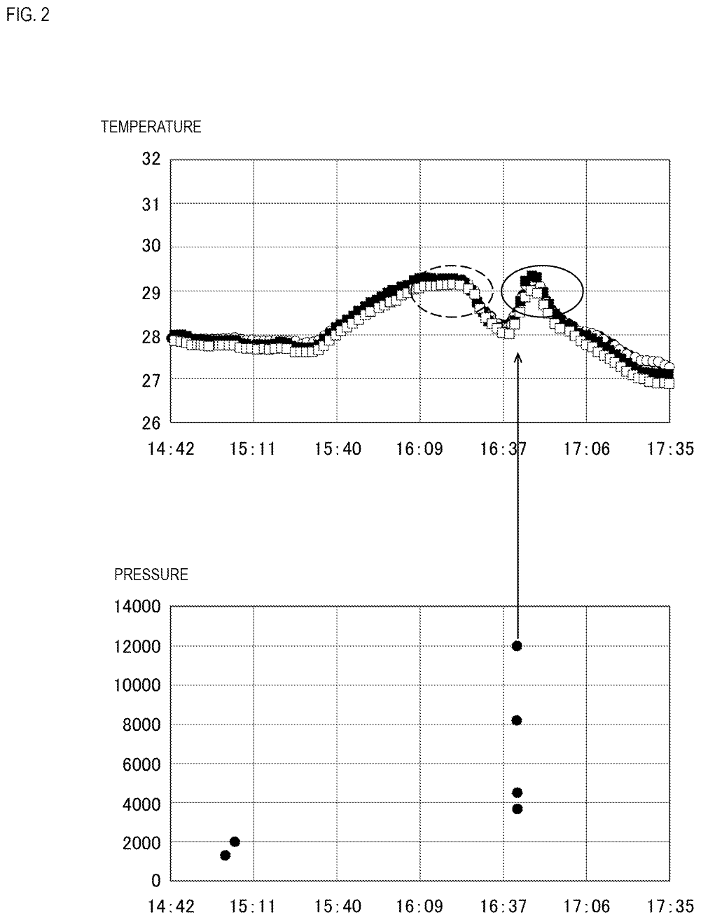

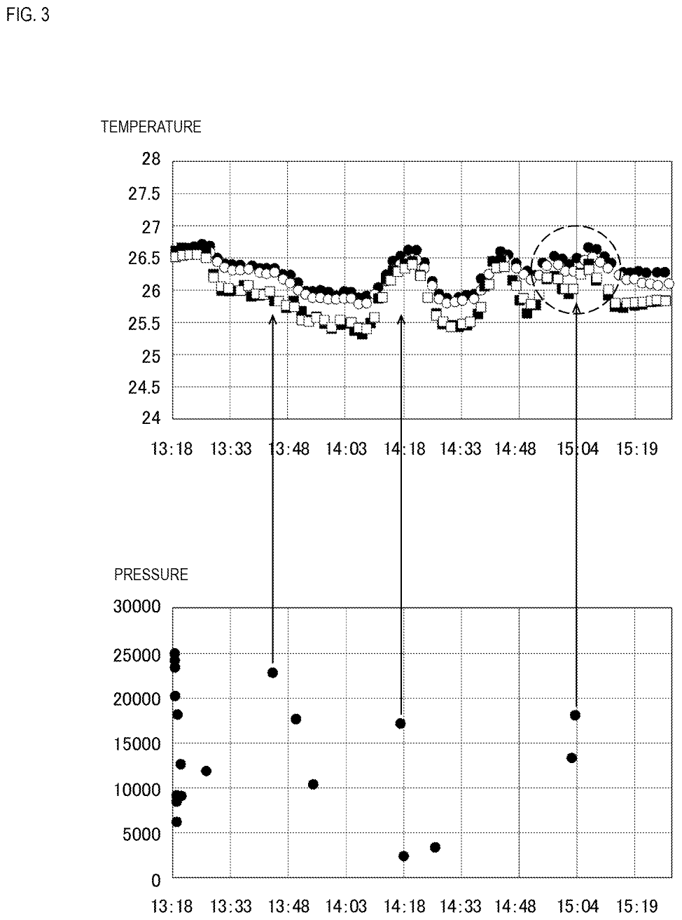

FIG. 2 is a diagram showing a relationship between a time-series change in the temperature and a time at which an elderly user presses a button. In an upper diagram of FIG. 2, a horizontal axis represents time, and a vertical axis represents temperature (° C.). Four graphs, though overlapped and hard to see, corresponding to temperature sensors at four positions are drawn. In a lower diagram of FIG. 2, a horizontal axis represents time, and a vertical axis represents pressure (relative values of the pressure sensors). “●” corresponds to pressing of either the hot button or the cold button. The same applies to FIG. 3. The following can be seen from FIG. 2.
In a time zone of a slow temperature change (broken-line ellipse), the elderly user does not press a button.
In a time zone of a rapid temperature change (solid-line ellipse), the elderly user presses the hot button.

FIG. 3 is a diagram showing a relationship between a time-series change in the temperature and a time at which a young user presses a button. As features compared with FIG. 2, the following can be seen from FIG. 3.
The young user presses the button for more times.
The young user presses the button with greater pressure.
The young user presses the hot button sensitively even when the temperature increases slightly (broken-line ellipse, 0.02° C./min to 0.04° C./min).

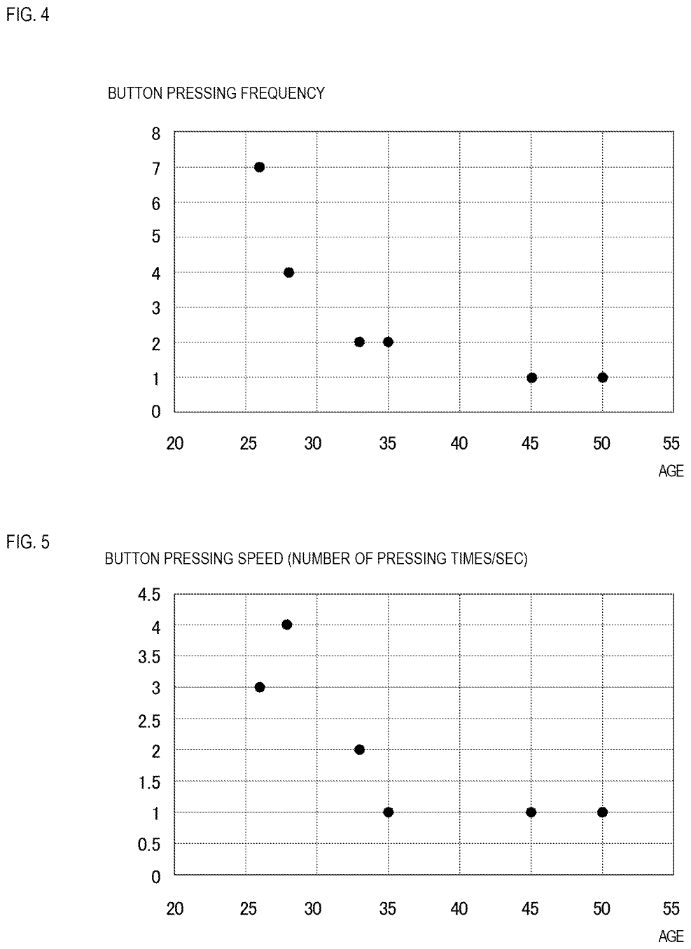

FIG. 4 is a diagram showing a relationship between an age of the user and a button pressing frequency. In FIG. 4, a horizontal axis represents the age of the user, and a vertical axis represents the frequency at which the button is pressed in the experiment period. When the user presses the button a plurality of times consecutively in a fairly short period (for example, one second), the number of times is also counted as an opportunity to press the button “once”. It can be seen from FIG. 4 that the older the age, the lower the frequency. In FIGS. 4 to 7, “●” corresponds to an opportunity to press the hot button or the cold button once. “The older the age” means, in other words, that “when an older user is compared with a younger user, the older user” (the same applies hereinafter).

FIG. 5 is a diagram showing a relationship between the age of the user and a button pressing speed. In FIG. 5, a horizontal axis represents the age of the user, and a vertical axis represents the speed at which the button is pressed. Here, the speed is the number of times per second the user presses the button in the opportunity to press the button “once”. It can be seen from FIG. 5 that the older the age is, the lower the speed tends to be.

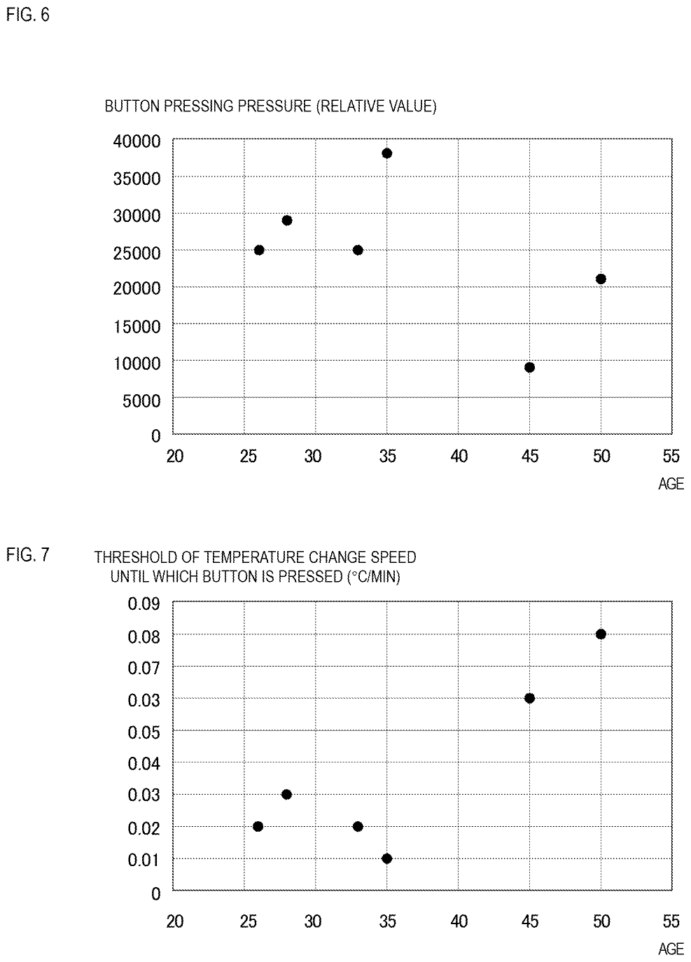

FIG. 6 is a diagram showing a relationship between the age of the user and button pressing pressure. In FIG. 6, a horizontal axis represents the age of the user, and a vertical axis represents a relative value of the pressure at which the button is pressed. It can be seen from FIG. 6 that the older the age is, the lower the pressure tends to be.

FIG. 7 is a diagram showing a relationship between the age of the user and a threshold of a temperature change speed until which the button is pressed. In FIG. 7, a horizontal axis represents the age of the user, and a vertical axis represents a temperature change speed when the button is pressed. It can be seen from FIG. 7 that the older the age, the smaller the threshold, that is, the more insensitive or uninterested in the temperature change.

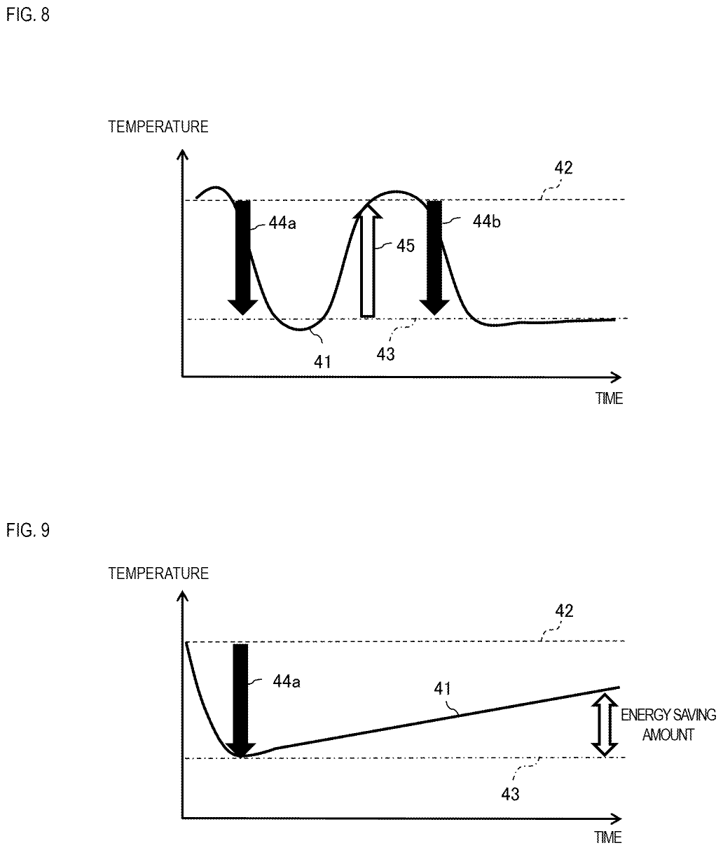

Features according to the present embodiment based on results of Non-Patent Literature 1 and the undisclosed experiment are described with reference to FIGS. 8 and 9 in the cooling environment in summer.

FIG. 8 is a diagram showing a time-series change in the sensor temperature in the cooling environment in summer in the related art. In FIG. 8, a horizontal axis represents time, and a vertical axis represents temperature. A curve 41 indicates a sensor temperature. A broken line 42 indicates an initial temperature. A dot-dash line 43 indicates a set temperature.
At a time indicated by a black arrow 44a, the user feels “hot” and decreases the set temperature. At this time, the set temperature 43 becomes the target temperature instead of the initial temperature 42. The sensor temperature 41 is decreased to around the set temperature 43. The black arrow indicates that the user intends to move the target temperature in a direction of the arrow from a viewpoint of self-comfort (the same applies hereinafter).
At a time indicated by a white arrow 45, the initial temperature 42 becomes the target temperature instead of the set temperature 43. The sensor temperature 41 is increased to around the initial temperature 42.
At a time indicated by a black arrow 44b, the user feels “hot” and decreases the set temperature. At this time, the set temperature 43 becomes the target temperature again instead of the initial temperature 42. The sensor temperature 41 is decreased again to around the set temperature 43.

FIG. 9 is a diagram showing a time-series change in the sensor temperature in the cooling environment in summer according to the first embodiment. In FIG. 9, a horizontal axis represents time, and a vertical axis represents temperature. The curve 41 indicates the sensor temperature. The broken line 42 indicates the initial temperature. The dot-dash line 43 indicates the set temperature.
At a time indicated by the black arrow 44a, the user feels “hot” and decreases the set temperature. At this time, the set temperature 43 becomes the target temperature instead of the initial temperature 42. The sensor temperature 41 is decreased to around the set temperature 43.
Then, the initial temperature 42 becomes the target temperature instead of the set temperature 43. The sensor temperature 41 gradually increases. A change speed at which the sensor temperature 41 increases at this time is lower than a change speed at which the sensor temperature 41 increases in FIG. 8.
In this case, the user does not notice a fact that the sensor temperature 41 increases. Alternatively, even if the user notices the fact that the sensor temperature 41 increases, the user does not intend to decrease the set temperature.
As a result, an amount equivalent to an area between the sensor temperature 41 and the set temperature 43 is recognized as an energy saving amount.

### Configuration and the Like of Behavioral Change Promoting Device

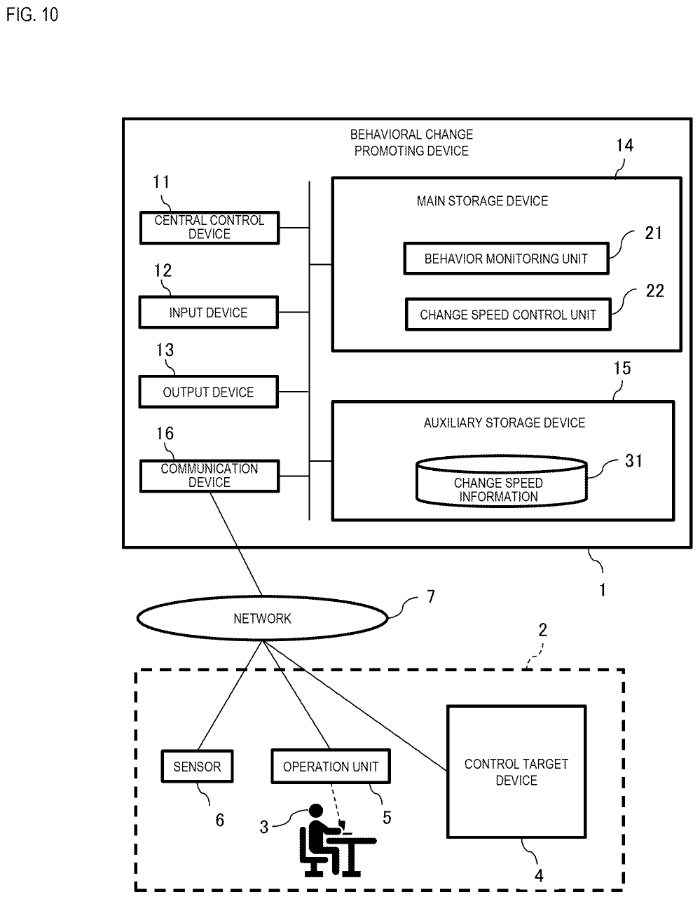

FIG. 10 is a diagram showing a configuration and the like of a behavioral change promoting device 1. The behavioral change promoting device 1 is a general computer, and includes a central control device 11, an input device 12 such as a mouse and a keyboard, an output device 13 such as a display, a main storage device 14, an auxiliary storage device 15, and a communication device 16. These devices are connected to one another via a bus. The auxiliary storage device 15 stores change speed information 31 (described in detail later).

A behavior monitoring unit 21 and a change speed control unit 22 in the main storage device 14 are programs. The central control device 11 reads these programs from the auxiliary storage device 15 and loads these programs into the main storage device 14, thereby implementing functions (described in detail later) of the programs. The auxiliary storage device 15 may be independent of an environment control device.

In an office 2, a user 3, a control target device 4, an operation unit 5, and a sensor 6 are present. The behavioral change promoting device 1 is connected to the control target device 4, the operation unit 5, and the sensor 6 via a network 7. Here, the control target device 4 is an air conditioner. The operation unit 5 is a remote controller or the like for the user 3 to set a set temperature for the control target device 4. The sensor 6 measures a temperature of air around the user 3. The behavioral change promoting device 1, the control target device 4, the operation unit 5, and the sensor 6 constitute a behavioral change promoting system.

### Change Speed Information

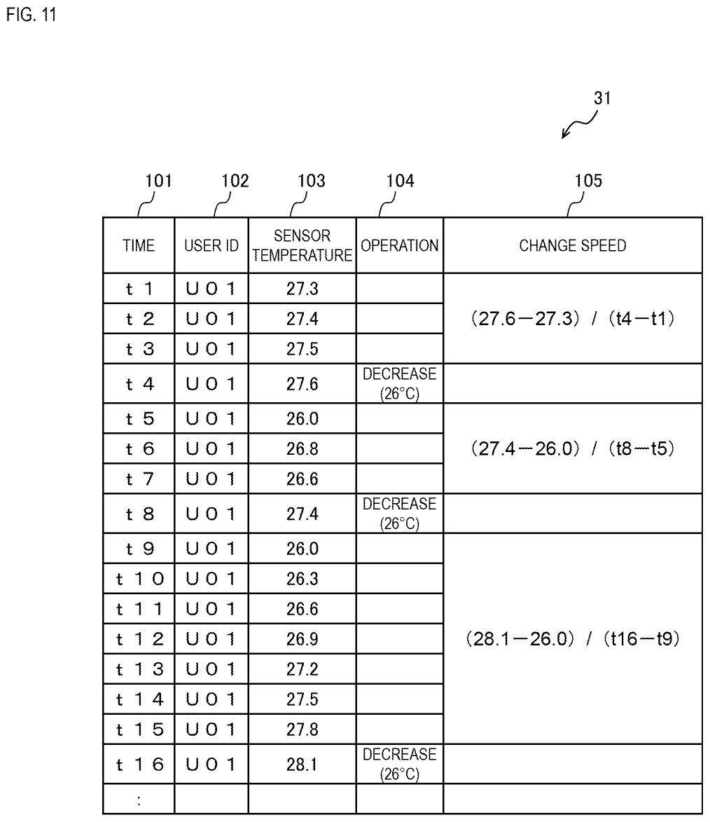

FIG. 11 is a diagram showing an example of the change speed information 31. In the change speed information 31, in association with times stored in a time column 101, user IDs are stored in a user ID column 102, sensor temperatures are stored in a sensor temperature column 103, operations are stored in an operation column 104, and change speeds are stored in a change speed column 105.

Each time in the time column 101 is a time at which the sensor 6 measures a temperature. The sensor 6 acquires the temperatures at a predetermined cycle (for example, every several minutes).

Each user ID in the user ID column 102 is an identifier for uniquely identifying a user.

Each sensor temperature in the sensor temperature column 103 is a value (° C.) of a temperature measured by the sensor 6.

Each operation in the operation column 104 is content of an operation performed on the operation unit 5 by the user 3. For example, “decrease (26° C.)” indicates that the user 3 feels hot and sets (decreases) the set temperature to 26° C. When the operation column 104 is blank, it indicates that the user 3 does not operate the operation unit 5 at that time.

A sensor temperature at a time t4 is higher than that at a time t1. A sensor temperature at a time t8 is higher than that at a time t5. This means that the behavioral change promoting device 1 performs control to return the target temperature from the set temperature (for example, 26° C.) to the initial temperature (for example, 28° C.).

Each change speed in the change speed column 105 is a value (° C./min) obtained by dividing a difference between sensor temperatures at two consecutive operation times when the user 3 operates the operation unit 5 by a difference between the two operation times. An initial change speed before a first operation time (t4) is a value (° C./min) obtained by dividing a difference between sensor temperatures at the time t1 and the first operation time (t4) by a difference between the time t1 and the first operation time.

### Processing Procedure

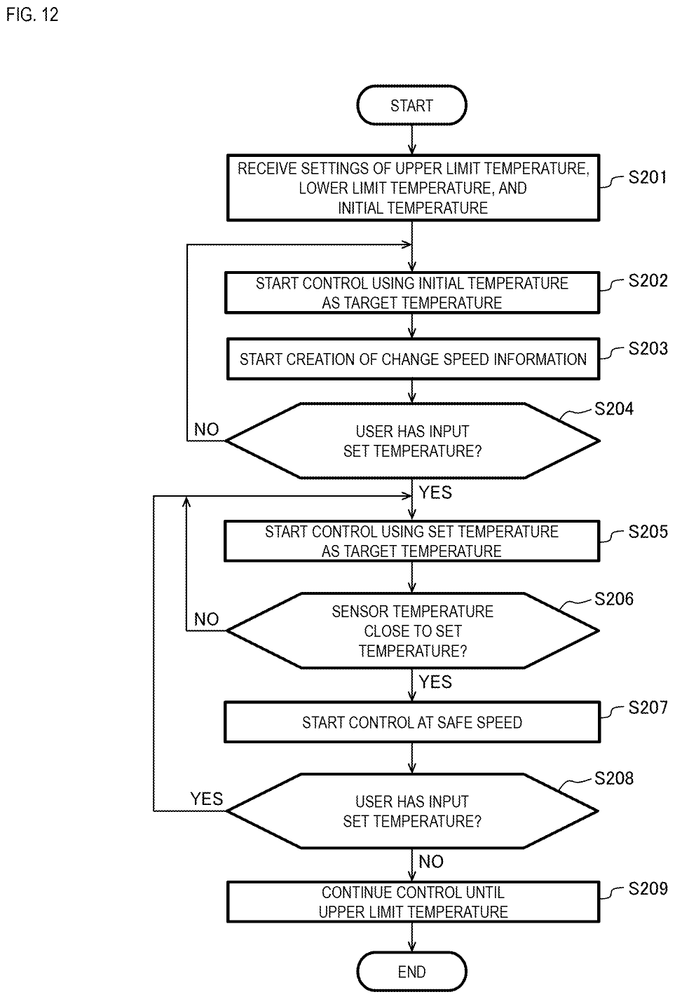

FIG. 12 is a flowchart of a processing procedure.

In step S201, the change speed control unit 22 of the behavioral change promoting device 1 receives settings of an upper limit temperature, a lower limit temperature, and an initial temperature. Specifically, the change speed control unit 22 receives, from the administrator, input of the upper limit temperature, the lower limit temperature, and the initial temperature via the input device 12. For convenience of description, it is assumed here that “28° C.” is input as the initial temperature in the cooling environment in summer.

In step S202, the change speed control unit 22 starts control using the initial temperature as the target temperature. Specifically, the change speed control unit 22 controls output or the like of the control target device 4 using 28° C. as the target temperature. As a result, the sensor temperature is eventually stabilized at about 28° C.

In step S203, the change speed control unit 22 starts creation of the change speed information 31 (FIG. 11). Specifically, the change speed control unit 22 creates records of the change speed information 31 one by one each time the predetermined cycle comes after this time.

The later processing procedure will be slightly described in advance. The change speed control unit 22 calculates the change speeds in FIG. 11 one by one each time “YES” in step S204 and “YES” in step S208 are passed. The change speed is a speed (unacceptable speed) determined to be too large by the user. The change speed control unit 22 constantly holds a minimum speed (minimum unacceptable speed) among such a plurality of unacceptable speeds.

In step S204, the behavior monitoring unit 21 of the behavioral change promoting device 1 determines whether the user has input the set temperature. The behavior monitoring unit 21 constantly monitors whether the user 3 has operated the operation unit 5. The operation unit 5 includes a “hot button”, a “cold button”, and a “set temperature input button”. Therefore, when the user 3 has input the set temperature (“YES” in step S204), the behavior monitoring unit 21 proceeds to step S205, and otherwise (“NO” in step S204), the behavior monitoring unit 21 returns to step S202. For convenience of description, it is assumed here that the “hot button” is pressed and “26° C.” is input as the set temperature.

In step S205, the change speed control unit 22 of the behavioral change promoting device 1 starts control using the set temperature as the target temperature. Specifically, the change speed control unit 22 controls the output or the like of the control target device 4 using 26° C. as the target temperature. As a result, the sensor temperature is eventually stabilized at about 26° C.

In step S206, the change speed control unit 22 determines whether the sensor temperature is close to the set temperature. Specifically, when the change speed control unit 22 detects that the sensor temperature falls within a range of “26° C.±α° C.” (“YES” in step S206), the change speed control unit 22 proceeds to step S207, and otherwise (“NO” in step S206), the change speed control unit 22 returns to step S205. Here, “α” is a minute value (for example, 0.5° C.), which is freely set by the administrator. For convenience of description, it is assumed that the sensor temperature reaches 26.5° C. (α=0.5).

Here, the change speed control unit 22 determines whether the sensor temperature is “close to” the set temperature rather than whether the sensor temperature reaches the set temperature. This is because, in general, when the sensor temperature is close to the set temperature, output of the air conditioner is automatically turned off (the sensor temperature does not reach the set temperature itself no matter how long waiting time is) in many cases.

In step S207, the change speed control unit 22 starts control at a safe speed. Specifically, first, the change speed control unit 22 calculates, as a safe change speed, a temperature obtained by subtracting a safe margin β from a currently held minimum unacceptable speed. For convenience of description, it is now assumed that the minimum unacceptable speed is “0.1° C./min” and the safe margin β is “0.03° C./min”.

Second, the change speed control unit 22 controls the output or the like of the control target device 4 so as to maintain a safe speed “0.07° C./min”. As a result, the sensor temperature increases almost without being noticed by the user 3.

In step S208, the behavior monitoring unit 21 of the behavioral change promoting device 1 determines whether the user has input the set temperature. Specifically, when the user 5 has input the set temperature (“YES” in step S208), the behavior monitoring unit 21 returns to step S205, and otherwise (“NO” in step S208), the behavior monitoring unit 21 proceeds to step S209.

In step S209, the change speed control unit 22 of the behavioral change promoting device 1 continues the control until the upper limit temperature is reached. Specifically, the change speed control unit 22 controls the control target device 4 at the safe speed until the sensor temperature reaches the upper limit temperature. After the sensor temperature has reached the upper limit temperature, the change speed control unit 22 controls the control target device 4 at a “change speed=0”. Thereafter, the processing procedure is ended.

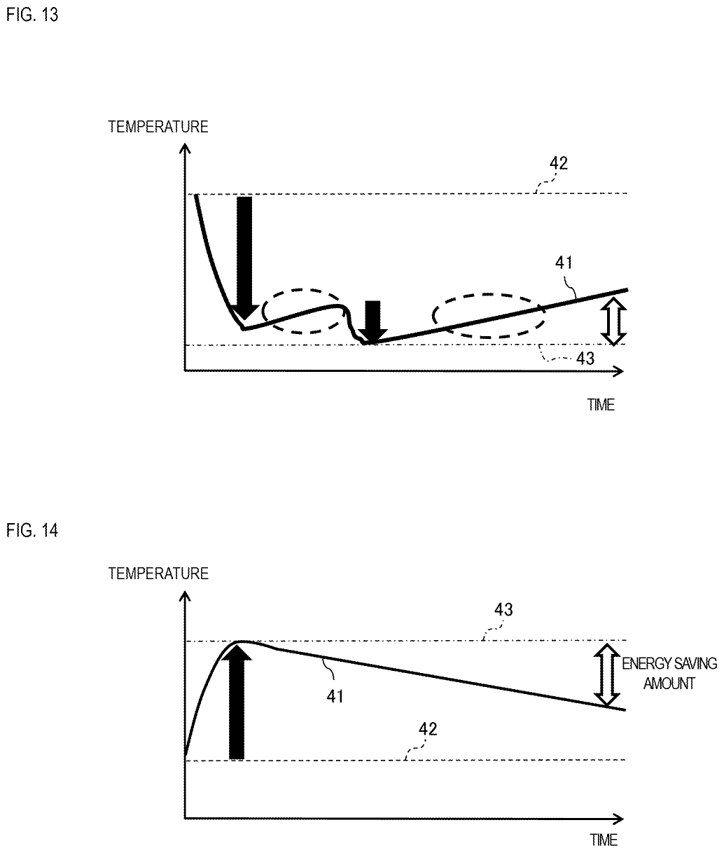

FIG. 13 is a diagram showing a time-series change in the sensor temperature in the processing procedure in FIG. 12. The sensor temperature 41 repeatedly increases and decreases. As time elapses, the change speed (a slope in broken-line ellipses) at which the sensor temperature 41 increases decreases. An area between the sensor temperature 41 and the set temperature 43 corresponds to an energy saving amount.

### Second Embodiment

In a second embodiment, summer according to the first embodiment is replaced with winter, and cooling is replaced with heating. Therefore, the description of the second embodiment is the same as that of the first embodiment except points as follows.
In the second embodiment, a magnitude relationship between the initial temperature 42 and the set temperature 43 is opposite to that according to the first embodiment.
In the first embodiment, the change speed (safe speed) is a positive value, and in the second embodiment, the change speed is a negative value.

FIG. 14 is a diagram showing a time-series change in the sensor temperature according to the second embodiment. The initial temperature 42 is below the set temperature 43. The change speed (safe speed) is expressed as a negative slope of the sensor temperature 41, and an area between the sensor temperature 41 and the set temperature 43 corresponds to an energy saving amount.

### Third Embodiment

In a third embodiment, the control target device 4 is an audio device that generates sounds. The operation unit 5 is a button for setting volume of the audio device. The sensor 6 measures the volume of the audio device. The user 3 listens to the sounds generated by the audio device via a headphone, an earphone, or the like, or directly listens to the sounds generated by the audio device without passing through the headphone, the earphone, or the like. The user 3 tends to increase the volume in order to accurately listen to the sounds. On the other hand, from a viewpoint of a surrounding person, the volume needs to be sufficiently low.

Description of the third embodiment is the same as that of the first embodiment except points as follows.
The “temperature” in the first embodiment is replaced with the “volume”.
A magnitude relationship between an initial volume 42 and a set volume 43 in the third embodiment is opposite to the magnitude relationship between the initial temperature 42 and the set temperature 43 in the first embodiment.
In the first embodiment, the change speed (safe speed) is a positive value, and in the third embodiment, the change speed is a negative value.

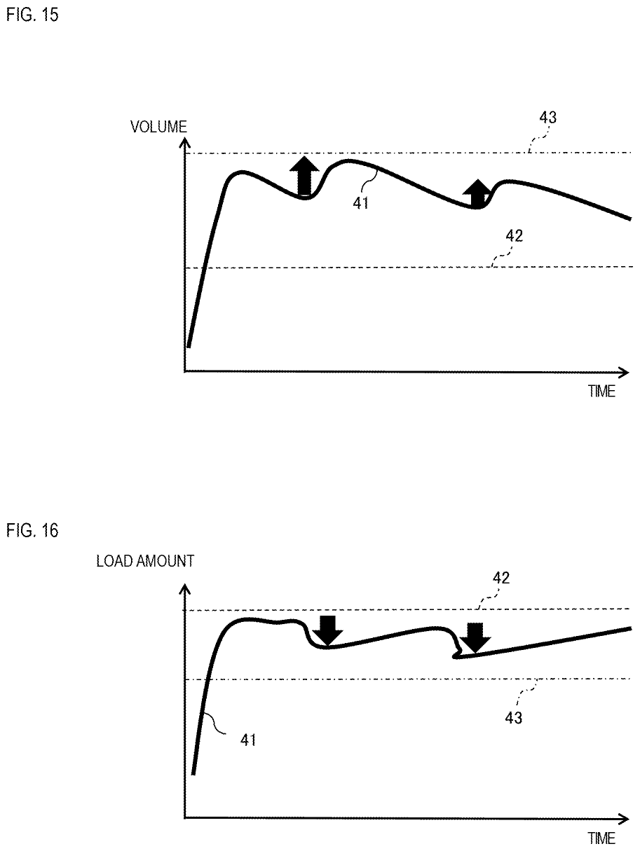

FIG. 15 is a diagram showing a time-series change in a sensor volume according to the third embodiment. The initial volume 42 is below the set volume 43. The change speed (safe speed) is expressed as a negative slope of the sensor volume 41.

### Fourth Embodiment

In a fourth embodiment, the control target device 4 is a training device for rehabilitation or training. The operation unit 5 is a button for setting a load amount of the training device. Here, the load amount is a running speed of a running machine, a contractile force of a spring that is applied in a direction opposite to muscular contraction in an arm cast, or the like. The sensor 6 measures the load amount. The user 3 uses and wears the training device and moves a body. The user 3 tends to reduce the load amount for ease. On the other hand, from viewpoints of physical function recovery and health maintenance, the load amount needs to be sufficiently large.

Description of the fourth embodiment is the same as that of the first embodiment except points as follows.
The “temperature” in the first embodiment is replaced with the “load amount”. That is, in the fourth embodiment, the training device corresponds to the control target device that acts on the human environment (sensation).

FIG. 16 is a diagram showing a time-series change in a sensor load amount according to the fourth embodiment. An initial load amount 42 is above a set load amount 43. A change speed (safe speed) is expressed as a positive slope of a sensor load amount 41.

### Fifth Embodiment

In a fifth embodiment, the control target device 4 is a lighting device in a bedroom or the like. The operation unit 5 is a button for setting a color temperature of the lighting device. The sensor 6 measures the color temperature. The user 3 sets the color temperature for sleeping at night. The user 3 tends to increase the color temperature when, for example, the user 3 is concerned about eyesight. On the other hand, from a medical point of view to prompt the user to feel calm and sleep deeply, the color temperature needs to be sufficiently low.

Description of the fifth embodiment is the same as that of the first embodiment except points as follows.
The “temperature” in the first embodiment is replaced with the “color temperature”.
A magnitude relationship between an initial color temperature 42 and a set color temperature 43 in the fifth embodiment is opposite to the magnitude relationship between the initial temperature 42 and the set temperature 43 in the first embodiment.
In the first embodiment, a change speed (safe speed) is a positive value, and in the fifth embodiment, the change speed is a negative value.

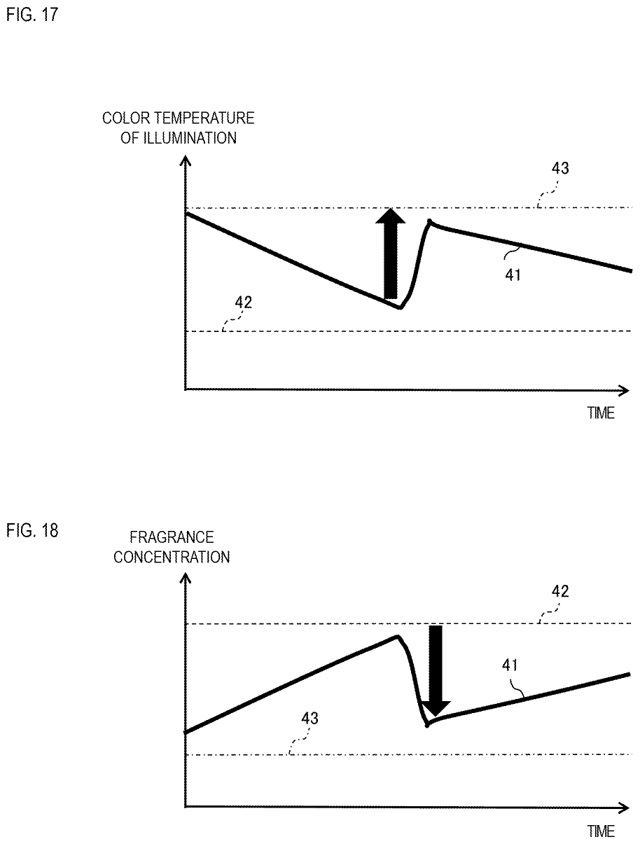

FIG. 17 is a diagram showing a time-series change in a sensor color temperature according to the fifth embodiment. The initial color temperature 42 is below the set color temperature 43. The change speed (safe speed) is expressed as a negative slope of a sensor color temperature 41.

### Sixth Embodiment

In a sixth embodiment, the control target device 4 is a fragrance sprayer. The fragrance sprayer contains a chemical component that can be recognized as a smell by the user among a drug that keeps the user conscious, a drug that prevents spread of infectious diseases, and the like. The operation unit 5 is a button for setting a fragrance concentration. Here, the fragrance concentration is a concentration (the number of moles of a specific chemical component contained in the air per unit volume) of a drug in the air. The sensor 6 measures the fragrance concentration. The user 3 inhales the drug discharged by the fragrance sprayer. The user 3 tends to worry about the fragrance of the drug and reduce the fragrance concentration. On the other hand, from a viewpoint of work efficiency of the user and an effect of preventing the spread of the infectious diseases, the fragrance concentration needs to be sufficiently high.

Description of the sixth embodiment is the same as that of the first embodiment except points as follows.
The “temperature” in the first embodiment is replaced with the “fragrance concentration”.

FIG. 18 is a diagram showing a time-series change in a sensor fragrance concentration according to the sixth embodiment. An initial fragrance concentration 42 is above a set fragrance concentration 43. The change speed (safe speed) is expressed as a positive slope of a sensor fragrance concentration 41.

The following can be said in common with the first to sixth embodiments.
A direction (comfort direction) in which a user intends to control the control target measurement value from a viewpoint of self-comfort is opposite to a direction (non-comfort direction) in which external constraints other than the comfort tend to control the control target measurement value.
Therefore, competition between the user and the external constraints is generated around a control target.
The control target measurement value can be controlled in the non-comfort direction without being noticed by the user. At this time, the user does not control the control target measurement value in the comfort direction.
Incidentally, the non-comfort direction is a direction in which energy consumed by the air conditioner is omitted in the first and second embodiments, a direction in which the volume is decreased in the third embodiment, a direction in which a human load is increased in the fourth embodiment, a direction in which the color temperature is decreased in the fifth embodiment, and a direction in which the fragrance concentration is increased in the sixth embodiment.

### Control Utilizing Pressing Frequency, Pressing Speed, and Pressing Pressure

In steps S204 and S208 in FIG. 12, the behavior monitoring unit 21 may determine that the user has input a set temperature only when at least one of the following conditions is satisfied.

<Condition 1> A button is pressed at a pressing frequency equal to or higher than a predetermined threshold.

<Condition 2> The button is pressed at a pressing speed equal to or higher than a predetermined threshold.

<Condition 3> The button is pressed at a pressing pressure equal to or higher than a predetermined threshold.

Further, the change speed control unit 22 may calculate a “set temperature weight” based on the pressing pressure or the like actually measured under at least one of the conditions 1 to 3. The set temperature weight adopts a value within a range of “100%±γ%”. In a heating environment in winter, the set temperature weight increases as the pressing pressure or the like increases, and in a cooling environment in summer, the set temperature weight decreases as the pressing pressure or the like increases. In addition, the change speed control unit 22 may correct the set temperature by multiplying an actually input set temperature by the set temperature weight. Further, the change speed control unit 22 may correct a safe speed by multiplying the safe temperature by the set temperature weight.

### Age Estimation

Based on experimental results in FIGS. 4 to 7, functions F₁, F₂, and F₃ are defined as follows. F₃ is a composite function of F₁ and F₂.

Change speed=F₁(age)

Age=F₂ (button pressing frequency, button pressing speed, button pressing pressure)

Change speed=F₃ (button pressing frequency, button pressing speed, button pressing pressure)

The change speed control unit 22 performs machine learning on the function F₁ and the function F₂ using past data as learning data, and then synthesizes the function F₃. As a result, the change speed control unit 22 performs machine learning on the function F₃. The change speed control unit 22 acquires at least one of the button pressing frequency, the button pressing speed, and the button pressing pressure for the current user 3, and inputs the acquired value into the function F₃. The change speed control unit 22 may set the change speed output by the function F₃ as the safe speed.

If such a function F₃ is used, even when the age of the user 3 is actually limited to a certain range (university, nursing home, or the like) or even when the age does not cause a problem, it is possible to determine the safe speed according to a mode of operation of the user 3.

### Determine Change Speed According to Age

A plurality of users may form a group among people in the same age group. In this case, the change speed control unit 22 may estimate the age of the user based on the mode (at least one of the button pressing frequency, the button pressing speed, and the button pressing pressure) of the operation, and increase the change speed as the estimated age increases. A fact that the age of the user can be estimated is fairly important for dealing with occasions other than an air-conditioning environment, such as meals, exercise, learning, and care preparation. Further, when the age group is known, the change speed control unit 22 may increase the change speed as the age increases.

### Operation by User

An example in which the user 3 (human) performs a button operation on the operation unit 5 is described above. However, the mode of operation performed by the user 3 includes following operations in addition to the button operation.
Touch the operation unit 5 (touch panel) with a finger
Input voice to the operation unit 5 (microphone)
Input vibration by hand to the operation unit 5 (accelerometer)
Any operation on the operation unit 5 (mouse and keyboard)

### Initial Value of Change Speed

In the above description, the change speed control unit 22 determines the change speed (safe speed) based on the minimum unacceptable speed. However, the change speed control unit 22 determines the initial change speed in any manner. The change speed control unit 22 may set, as the initial change speed, a change speed that is revealed to be not strongly stimulating for the user according to known research or the like in the field.

### Effects According to Present Embodiment

Effects of a behavioral change promoting device according to the present embodiment are as follows.

(1) The behavioral change promoting device can determine a change speed at which a control target measurement value changes in a non-comfort direction of a human based on an operation performed on a control target device by the human.

(2) The behavioral change promoting device can increase the change speed as an age of a human increases.

(3) The behavioral change promoting device can perform machine learning on a function that outputs a change speed.

(4) The behavioral change promoting device can accurately determine the change speed based on a time interval at which the operation performed by the human occurs and a change in the control target measurement value at the time interval.

(5) The behavioral change promoting device can determine a limited change speed at which the human does not control the control target measurement value in a comfort direction.

(6) The behavioral change promoting device can correct the change speed based on a mode of the operation of the human.

(7) The behavioral change promoting device can take, as the mode of the operation, a number obtained by easy measurements such as a frequency, a speed, and a pressure.

(8) The behavioral change promoting device can be applied to an air conditioner, an audio device, a training device, a lighting device, and a fragrance sprayer.

The invention is not limited to the embodiments described above, and includes various modifications. For example, the above embodiments are described in detail for easy understanding of the invention, and the invention is not necessarily limited to those including all the configurations described above. Further, a part of the configuration according to one embodiment can be replaced with the configuration according to another embodiment, and the configuration according to one embodiment can be added to the configuration according to another embodiment. A part of the configuration according to each embodiment may be added, deleted, or replaced with another configuration.

Configurations, functions, processing units, processing methods and the like described above may be partially or entirely implemented by hardware by, for example, designing with an integrated circuit. Further, each of the above-described configurations, functions, and the like may be implemented by software by interpreting and executing a program for implementing each function by a processor. Information such as a program, a table, and a file for implementing each function can be stored in a recording device such as a memory, a hard disk, and a solid state drive (SSD), or in a recording medium such as an IC card, an SD card, and a DVD.

Control lines and information lines are considered to be necessary for description, and all control lines and information lines are not necessarily shown in a product. It may be considered that almost all the configurations are actually connected to each other.

What is claimed is:

1. A behavioral change promoting device connected to a control target device configured to act on an environment of a human, an operation unit configured to receive an operation performed on the control target device by the human, and a sensor configured to acquire a control target measurement value in the environment, the behavioral change promoting device comprising:
a change speed control unit configured to determine, based on the received operation, a change speed at which the control target measurement value is changed in a non-comfort direction of the human.

2. The behavioral change promoting device according to claim 1, wherein
the change speed control unit estimates an age of the human based on a mode of the operation, and increases the change speed as the estimated age increases.

3. The behavioral change promoting device according to claim 1, wherein
the change speed control unit performs, using past data, machine learning on a function having a mode of the operation as input and the change speed as output.

4. The behavioral change promoting device according to claim 1, further comprising:
a behavior monitoring unit configured to monitor the operation, wherein
the change speed control unit determines the change speed based on a time interval at which the operation occurs and a change in the control target measurement value at the time interval.

5. The behavioral change promoting device according to claim 4, wherein
the change speed control unit stores a plurality of past examples of the change speed, and determines a change speed in the future based on a minimum change speed among the stored change speeds.

6. The behavioral change promoting device according to claim 5, wherein
the change speed control unit corrects the change speed based on a mode of the operation.

7. The behavioral change promoting device according to claim 6, wherein
the mode of the operation includes at least one of a frequency, a speed, and a pressure of the operation.

8. The behavioral change promoting device according to claim 1, wherein
when the control target device is an air conditioner, the non-comfort direction is a direction in which energy consumed by the air conditioner is omitted.

9. The behavioral change promoting device according to claim 1, wherein
when the control target device is an audio device, the non-comfort direction is a direction in which volume is decreased.

10. The behavioral change promoting device according to claim 1, wherein
when the control target device is a training device, the non-comfort direction is a direction in which a human load is increased.

11. The behavioral change promoting device according to claim 1, wherein
when the control target device is a lighting device, the non-comfort direction is a direction in which a color temperature is decreased.

12. The behavioral change promoting device according to claim 1, wherein
when the control target device is a fragrance sprayer, the non-comfort direction is a direction in which a fragrance concentration is increased.

13. A behavioral change promoting system comprising:
a control target device configured to act on an environment of a human;
an operation unit configured to receive an operation performed on the control target device by the human;
a sensor configured to acquire a control target measurement value in the environment; and
a behavioral change promoting device including a change speed determination unit configured to determine, based on the received operation, a change speed at which the control target measurement value is changed in a non-comfort direction of the human.

14. A behavioral change promoting method using a behavioral change promoting device, the behavioral change promoting device being connected to a control target device configured to act on an environment of a human, an operation unit configured to receive an operation performed on the control target device by the human, and a sensor configured to acquire a control target measurement value in the environment, the behavioral change promoting method comprising:
determining, by a change speed determination unit of the behavioral change promoting device and based on the received operation, a change speed at which the control target measurement value is changed in a non-comfort direction of the human.
